(19) United States
(12) Patent Application Publication
(10) Pub. No.: US 2002/0156644 A1
(43) Pub. Date: Oct. 24, 2002

(54) Separation of duties for business process risk management

(75) Inventors: James J. Davies, Brookfield, CT (US); Robert D. Iannucci, Wilton, CT (US); Patricia C. Kelly, Danbury, CT (US); Richard B. Parker, Silver Spring, MD (US); Barry M. Rosenberg, Hopewell Junction, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/047,577

(22) Filed: Jan. 15, 2002

Related U.S. Application Data
(60) Provisional application No. 60/284,466, filed on Apr. 18, 2001.

(51) Int. Cl. G06F 17/60

(52) U.S. Cl. 705/1; 705/7

(57) ABSTRACT

A method, system and program product for separating duties of people carrying out a business process where they have conflicting tasks to minimize the risk in the business process. The invention is deploy-able across organizational structures and provides adequate control points and identification of conflicting tasks. As a result, the business process will be effective, auditable and the likelihood of fraud or error will be minimized.

This application claims priority to U.S. provisional patent application serial No. 60/284,466, filed Apr. 18, 2001 under 35 U.S.C. §119(e).

### BACKGROUND OF THE INVENTION

1. Technical Field

The present invention relates generally to risk management, and more particularly, to separation of duties for business process risk management.

2. Related Art

Developing and deploying a global business process while reducing accompanying risks is difficult. One cause of this difficulty is the need to make fast paced changes in business strategy to adjust to market changes and/or maintain revenue growth. In this case, the need to make quick decisions oftentimes leads to fragmented management processes across organizational structure such as geography, brand or other departmental organization. Unfortunately, each organizational structure responds by developing their own management system to handle new strategies. This weak and inconsistent control structure creates opportunities for asset-command loss, fraud, inconsistent treatment of customers and partners, and a proliferation of activities that may be inconsistent with an overall strategic direction. In addition, the myriad of management systems makes auditing more difficult.

In terms of fraud, for example, it is favorable that in a process for ordering, reviewing, approving and paying for goods and services that the person who places the order is not the one who also approves the order. Alternatively, it is also favorable that the same person who submits an invoice for payment should not be the one who processes the payment.

While reducing business risk by monitoring for the above-identified problems may seem relatively straightforward, the task becomes extremely difficult if the process is complex. That is, there are numerous steps, sub-processes, and many employees.

In view of the foregoing, there is a need in the art for a simple way to minimize risk in a business process in which people carrying out the business process may have conflicting tasks.

### SUMMARY OF THE INVENTION

The invention includes a method, system and program product for separating duties of people carrying out a business process where they have conflicting tasks to minimize the risk in the business process. The invention is deploy-able across organizational structures and provides adequate control points and identification of conflicting tasks. As a result, the business process will be effective, auditable and the likelihood of fraud or error will be minimized.

A first aspect of the invention is directed to a method of reducing risk in a business process, the method comprising the steps of: dividing the business process into component tasks; identifying for each of the component tasks any other component task that conflict with the component task; establishing at least one assigned task performed by each person involved in the business process; and determining which of the at least one assigned task is a conflicting task.

A second aspect of the invention is directed to a system for reducing risk in a business process, the system comprising: means for dividing the business process into component tasks; means for identifying for each of the component tasks any other component task that conflict with the component task; means for establishing at least one assigned task performed by each person involved in the business process; and means for determining which of the at least one assigned task is a conflicting task.

A third aspect of the invention is directed to a computer program product comprising a computer useable medium having computer readable program code embodied therein for reducing risk in a business process, the program product comprising: program code configured to divide the business process into component tasks; program code configured to identify for each of the component tasks any other component task that conflict with the component task; program code configured to establish at least one assigned task performed by each person involved in the business process; and program code configured to determine which of the at least one assigned task is a conflicting task.

The foregoing and other features and advantages of the invention will be apparent from the following more particular description of preferred embodiments of the invention.

### BRIEF DESCRIPTION OF THE DRAWINGS

The preferred embodiments of this invention will be described in detail, with reference to the following figures, wherein like designations denote like elements, and wherein:

FIG. 1 shows a block diagram of a risk reduction system 10;

FIG. 2 is a flow diagram showing a business risk reduction method;

FIG. 3 shows a task table showing potentially conflicting tasks;

FIG. 4 shows an employee task table showing tasks performed by a selected employee; and

FIG. 5 shows a conflicting task table for the selected employee.

### DETAILED DESCRIPTION OF THE INVENTION

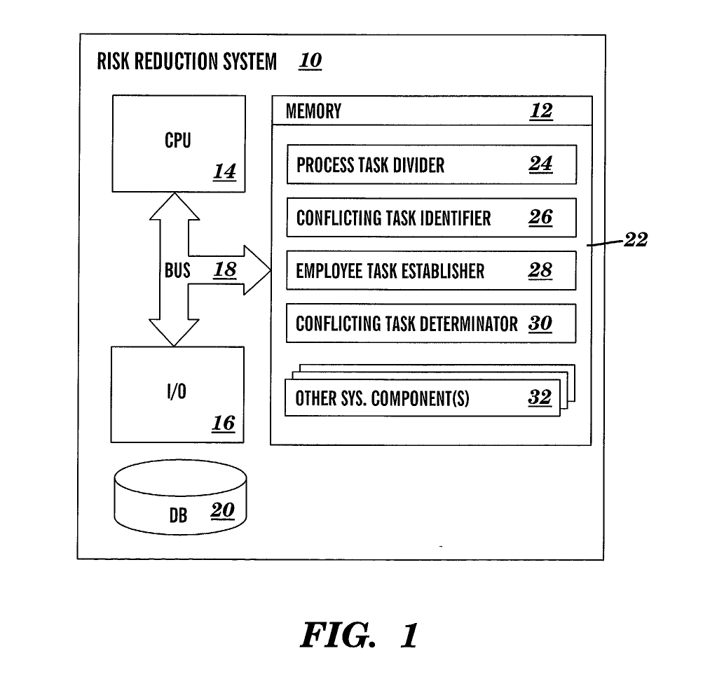

With reference to the accompanying drawings, FIG. 1 is a block diagram of a risk reduction system 10 in accordance with the invention. Risk reduction system 10 preferably includes a memory 12, a central processing unit (CPU) 14, input/output devices (I/O) 16 and a bus 18. A database 20 may also be provided for storage of data relative to processing tasks. Memory 12 preferably includes a program product 22 that, when executed by CPU 14, comprises various functional capabilities described in further detail below. Memory 12 (and database 20) may comprise any known type of data storage system and/or transmission media, including magnetic media, optical media, random access memory (RAM), read only memory (ROM), a data object, etc. Moreover, memory 12 (and database 20) may reside at a single physical location comprising one or more types of data storage, or be distributed across a plurality of physical systems. CPU 14 may likewise comprise a single processing unit, or a plurality of processing units distributed across one or more locations. A server computer typically comprises an advanced mid-range multiprocessor-based server, such as the RS6000 from IBM, utilizing standard operating system software, which is designed to drive the operation of the particular hardware and which is compatible with other system components and I/O controllers. I/O 16 may comprise any known type of input/output device including a network system, modem, keyboard, mouse, scanner, voice recognition system, CRT, printer, disc drives, etc. Additional components, such as cache memory, communication systems, system software, etc., may also be incorporated into system 10.

As shown in FIG. 1, program product 22 may include a process task divider 24, a conflicting task identifier 26, an employee task establisher 28, a conflicting task determinator 30 and other system components 32. While implementation of the invention will be described relative to the above program product, it should be recognized that the invention may be implemented using other mechanisms such as a spreadsheet application like Lotus 123. Operation of system 10, program product 22 and the method of the invention will become apparent from the following description.

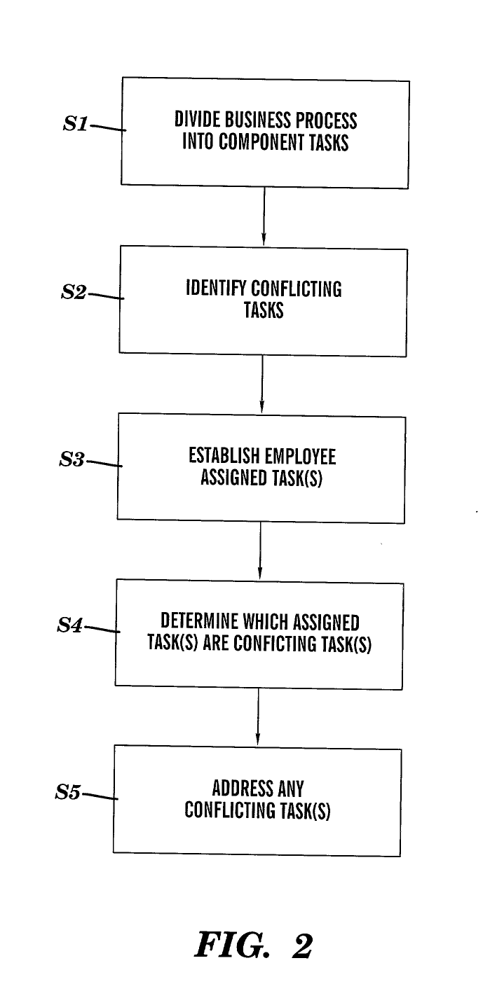

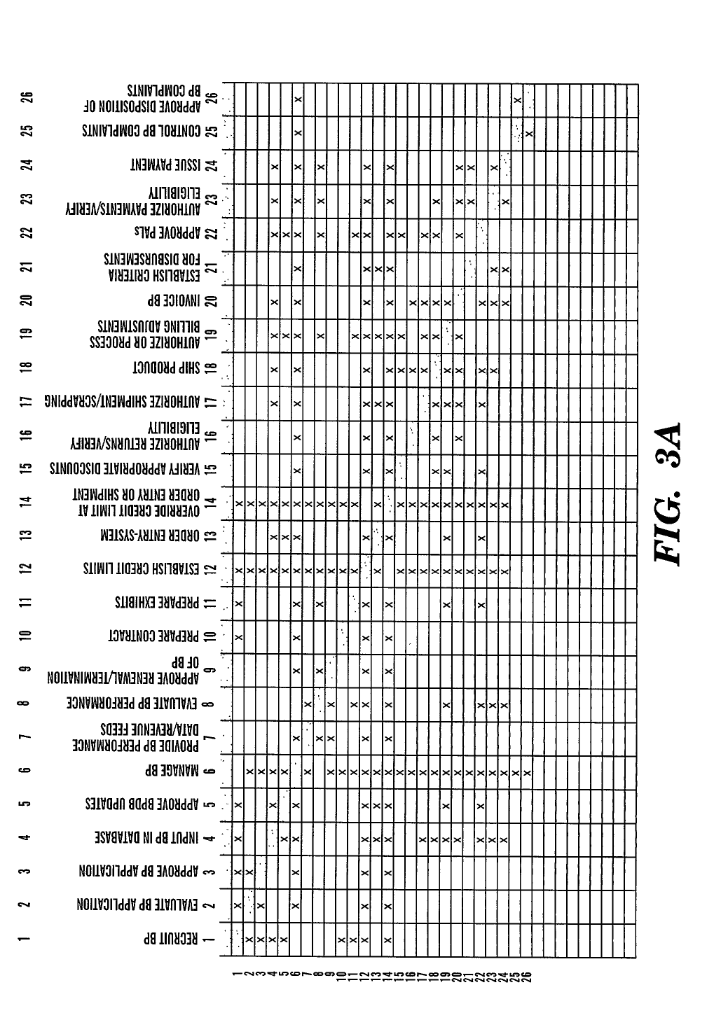

Referring to FIG. 2, a flow diagram of the business risk reduction method is illustrated. In step S1, a business process must be analyzed by breaking it down into its component steps or tasks (hereinafter “tasks”). This step may be accomplished manually through a graphical user interface of process task divider 24. Alternatively, this step may be completed automatically where more advanced logic is available and the business process lends itself to such analysis. One exemplary business process in which the invention finds advantage is that of identifying, nominating and qualifying potential candidates for marketing relationships. Of course, practically any business process can similarly be evaluated by the invention. In this example, the marketing partner is referred to as a “business partner” or BP. The process can be divided into, for example, twenty six tasks having the descriptions/responsibilities that follow:

1. Recruit—Identifies, nominates and pre-qualifies a candidate for consideration as a BP. Prequalification includes determining that the candidate's technical and marketing experience is in conformance with requirements.

2. Evaluate BP Application—Evaluation of the application and the supporting documentation consistent with documented selection criteria including the required reviews, e.g., not on an unapproved list, financial viability, credit check. The reviewers are not the evaluator. The evaluator, who may be a reviewer but cannot be the recruiter, collects the documented reviews for presentation to the decision maker.

3. Approve BP Application—May be an individual or a committee.

4. Input BP to Database—Establishes the BP in a database that would entitle it to any and all benefits as a BP.

5. Approve Database Updates—Verifies that the information input to the system in Task 4 is accurate and supported by required documentation.

6. Manage BP—Day to day management of assigned BPs. It is not intended to apply to individuals who are responsible for the strategy and development of the business partner programs for all BPs.

7. Provide BP Performance Data/Revenue Feeds—Ensures that the information for all BPs is consistently provided from internal systems according to established ground rules.

8. Evaluate BP Performance—Based upon the information provided (Task 7) this task is intended to be performed by the individual who is responsible for the day to day management of the BP. The evaluation results in a recommendation to provide a notice of deficiency, renewal or termination. It is not a report prepared by an administrative person in support of the sales organization which provides analysis.

9. Approve Renewal/Termination of BP—This task is best performed by a review board or committee, using criteria such as performance data provided by independent administrative source, the evaluations provided by a client representative, accounts receivable, and customer satisfaction history.

10. Prepare Contracts—Preparation of a contract.

11. Prepare Exhibits—Preparation of the exhibit conditions, to include products authorized, discount structure, etc.

12. Establish Credit Limits—Establishment of the credit limit provided for a specific BP, based on evaluation of organization and financial structure.

13. Order Entry-System—Input of the order in the system, responsible for credit line and firm order policy monitoring prior to entry to system.

14. Override Credit Limit at Order Entry or Shipment—By financial organization.

15. Verify Appropriate Discounts—Verify any discounts permitted by the contract or by additional announced promotions is required at the time of order entry by an individual other than the one who will receive commission on the sale.

16. Authorize Returns/Verify Eligibility—Returns should only be authorized after verification against the contract or other approved documented programs.

17. Authorize Shipments/Scrapping—Authorizes shipment or scrapping of equipment after validation that all documentation is properly approved, and that the equipment prepared to be shipped or scrapped is the same as identified on the order.

18. Ship Product—Has physical access to and controls the product during shipment and after receiving authorization to ship the equipment.

19. Authorize or Process Billing Adjustments—Includes any adjustments to invoices inconsistent with the business partner contract or the processed order. This includes the correction of revenue feed information which is manually entered.

20. Invoice BP—Prepares the invoice upon advice that the product has been shipped and the validation of all the supporting paperwork.

21. Establish Criteria for Disbursement—Preparation, and sign-off of criteria for the disbursement, e.g., exhibit for fee payments, establishment of performance bonuses.

22. Authorize Payments/Verify Eligibility—Authorizes the disbursement by validating the claim against pre-established criteria for disbursement, verifying that the equipment/service has been delivered, and the installation/service has been performed, and the appropriate percentages of fee are consistent with the exhibit.

23. Issue Payments—Payment of the claim, whether it is be by issuing a payment, or issuing a credit memo.

24. Control BP Complaints—Includes the logging in of the complaint, the assignment of the complaint to the appropriate owner, the follow up to ensure that the complaint is resolved in a timely manner, and root cause analysis of recurring complaints.

25. Approve Supplemental Payments (PALs)

26. Approve Disposition of BP Complaints—Review and approval of the final disposition of the complaint by or about a BP.

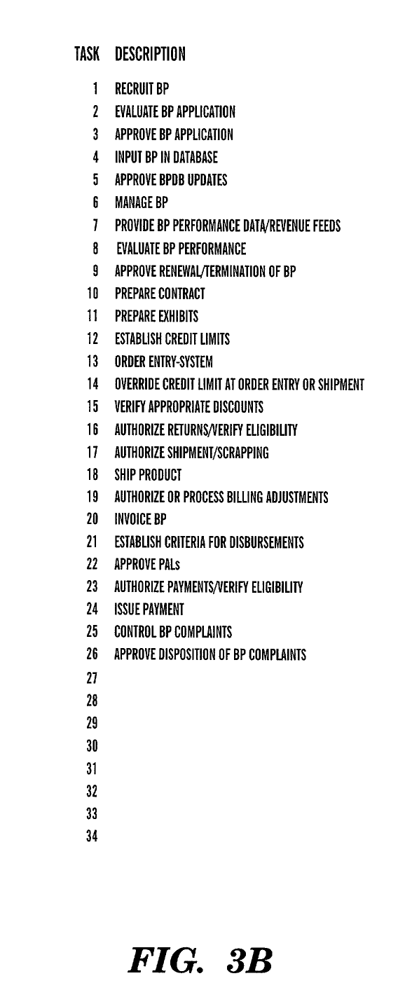

Next, in step S2, each of the component tasks that conflict with any other component task are identified. Some potential conflicts are noted in the above description. For example, the tasks of submitting an invoice for payment and approving the payment are conflicting tasks. This step may be accomplished manually through a graphical user interface of conflicting task identifier 26. Alternatively, this step may be completed automatically where more advanced logic is available and the business process lends itself to such analysis. For instance, tasks may be identified by a code that is recognized by identifier 26 such that various business processes can be implemented and conflicting tasks identified by code. FIG. 3 illustrates one embodiment using a spreadsheet application such as Lotus 123. The matrix created by the spreadsheet has the component tasks listed on the horizontal and vertical axes and an “X” marking conflicting tasks.

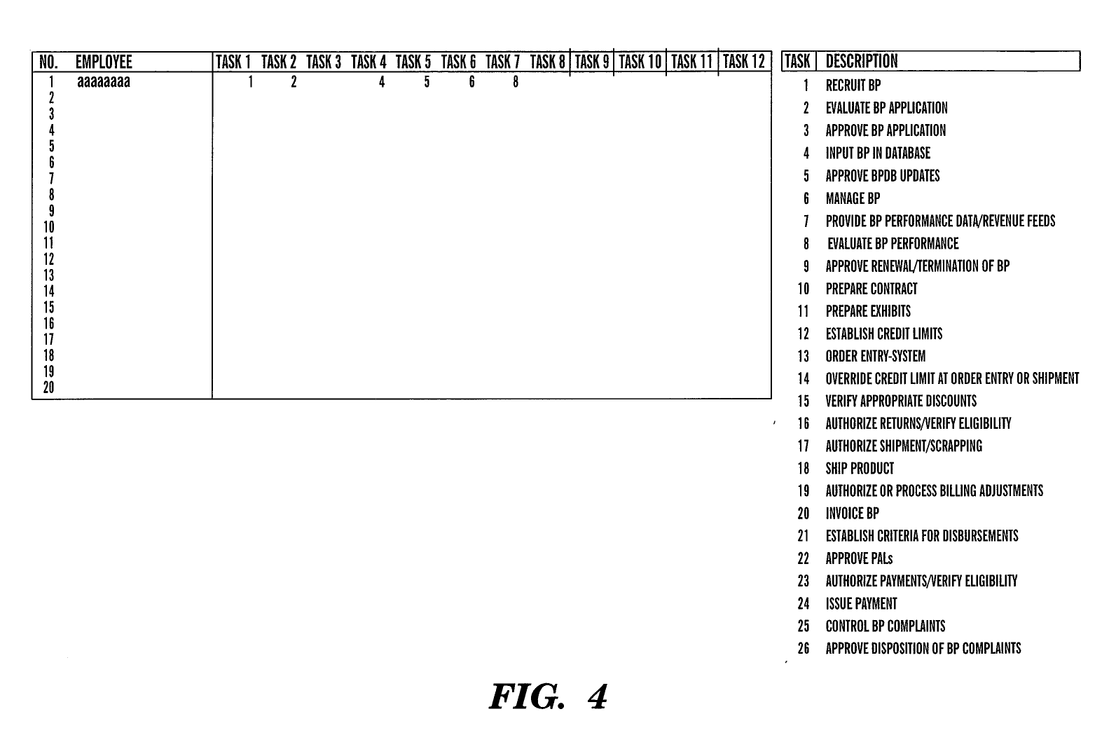

In step S3, at least one assigned task performed by each person involved in the business process is established. This step may be accomplished manually through a graphical user interface of employee task establisher 28. Alternatively, this step may be completed automatically where more advanced logic is available. For instance, an employee identifier may have associated therewith tasks that an employee is assigned to carry out. FIG. 4 illustrates a graphical user interface where the tasks of an employee “aaaaaaaa” are listed. This employee has assigned tasks 1, 2, 4, 5, 6 and 8.

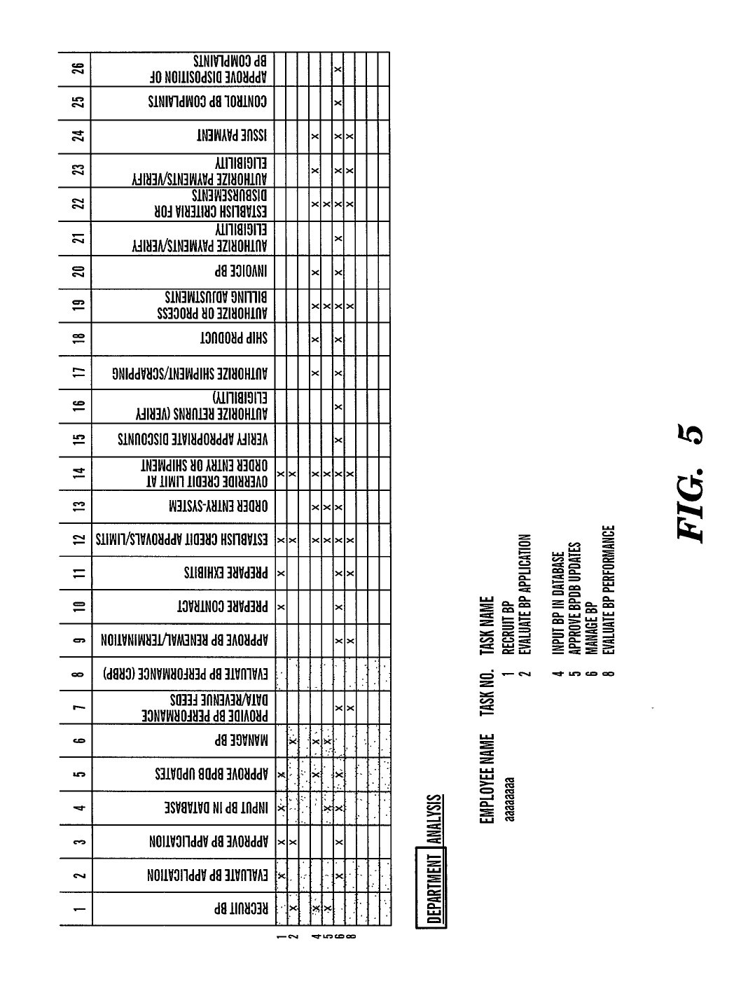

In step S4, a determination of which of the at least one assigned task is a conflicting task is made. This step is accomplished by conflicting task determinator 30 comparing each employee's assigned tasks with the conflicting task matrix (FIG. 3). FIG. 5 illustrates a resulting matrix showing the employee's conflicting tasks. For instance, employee's assigned task of ‘Recruit BP’ conflicts with Tasks 2-6, 10-12 and 14. Most notably, recruiting a BP conflicts with evaluating a BP's application, Task 2, and approving a BPs application. Where conflicting tasks exist, the matrix may be highlighted accordingly to draw a user's attention.

In step S5, the step of addressing any conflicting task occurs. This step may involve a number of measures. For instance, employee re-assignment, network activity lockouts, administrative signature requirement, etc.

Using the above described invention provides a simple way to minimize risk in a business process in which people carrying out the business process may have conflicting tasks. In addition, the tasks and/or assigned employees may be readily modified and reanalyzed to determine the effects of the changes. This permits a complex business process to be analyzed in a minimum amount of time.

In the previous discussion, it will be understood that the method steps discussed preferably are performed by a processor, such as CPU 14 of system 10, executing instructions of program product 22 stored in memory. It is understood that the various devices, modules, mechanisms and systems described herein may be realized in hardware, software, or a combination of hardware and software, and may be compartmentalized other than as shown. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after the following: (a) conversion to another language, code or notation; and/or (b) reproduction in a different material form.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A method of reducing risk in a business process, the method comprising the steps of:
dividing the business process into component tasks;
identifying for each of the component tasks any other component task that conflict with the component task;
establishing at least one assigned task performed by each person involved in the business process; and
determining which of the at least one assigned task is a conflicting task.

2. The method of claim 1, wherein the steps are performed by a computer software program.

3. The method of claim 1, further comprising the step of addressing any conflicting task.

4. A system for reducing risk in a business process, the system comprising:
means for dividing the business process into component tasks;
means for identifying for each of the component tasks any other component task that conflict with the component task;
means for establishing at least one assigned task performed by each person involved in the business process; and
means for determining which of the at least one assigned task is a conflicting task.

5. The system of claim 4, wherein the means for identifying includes a matrix identifying conflicting tasks.

6. The system of claim 5, wherein the means for determining compares the at least one assigned task to the conflicting tasks on the matrix.

7. A computer program product comprising a computer useable medium having computer readable program code embodied therein for reducing risk in a business process, the program product comprising:
program code configured to divide the business process into component tasks;
program code configured to identify for each of the component tasks any other component task that conflict with the component task;
program code configured to establish at least one assigned task performed by each person involved in the business process; and
program code configured to determine which of the at least one assigned task is a conflicting task.

8. The system of claim 7, wherein the program code configured to identify includes a matrix identifying conflicting tasks.

9. The system of claim 8, wherein the program code configured to determine compares the at least one assigned task to the conflicting tasks on the matrix.
